(19) United States
(12) Patent Application Publication
(10) Pub. No.: US 2016/0225100 A1
(43) Pub. Date: Aug. 4, 2016

(54) Methods and System for Raising Funds From and Distributing Royalties to Multiple Recipients Over the Internet

(71) Applicant: Enrique Parrila, Houston, TX (US)

(72) Inventor: Enrique Parrila, Houston, TX (US)

(21) Appl. No.: 14/609,287

(22) Filed: Jan. 29, 2015

(51) Int. Cl. G06Q 40/00

(52) U.S. Cl. CPC G06Q 40/12

(57) ABSTRACT

In one embodiment of the present disclosure, a computer implemented method comprises using an electronic server to receive at least a description and required budget of a literary project through an electronic device; displaying the description and the required budget on an internet platform or mobile application; receiving money from one or more backer who want to fund the literary project; calculating weighted contribution for each of the one or more backers who funded the project; publishing the literary project after the required budget is met; receiving revenues generated by the literary project; and paying royalties to the backers based on their weighted contribution.

### FIELD OF THE DISCLOSURE

The present disclosure generally relates to methods and systems for raising funds for a literary project and paying royalties to backers once the literary project generates sales. More specifically, the present disclosure relates to methods and systems where author of a literary project uses an online platform to raise funds for his or her literary project by attracting and obtaining financial support from backers who will finance and promote the literary work and the platform will distributes royalties to the backers of the project based on their weighted financial or other contribution once the literary work is sold.

### BACKGROUND

One of the hurdles faced by an author of a literary work is to find a publisher that is willing to finance and publish the author's work. While some authors can publish their work without any financial assistance, most authors, especially less famous ones, will need financial assistance of some sort to help them to get the resources they need.

There are many ways to fund a literary work such as securing a loan from a bank or preselling the work that has not been created. However, these methods often are ineffective for small projects or less famous authors because the bank usually prefers providing the loan to large projects or famous authors, and most consumers have little incentive to support literary work that has not yet been published.

Another popular way to fund a literary work is through crowdfunding. Crowdfunding website like Unbound® and Pubslush® allows a user to listen to author's ideas for what the author would like to write before the author even start. If the user likes the author's idea, the user can pledge to support it. Once the number of supporters hit the author's target, the author can go ahead and start writing. In general, the higher the user's pledge, the greater the rewards the user will receive.

Another common hurdle faced by many authors is not having an idea of how to market and promote their literary work. Too often their idea of a marketing strategy is to post about their projects on social media, hand out flyers and market and advertize. While those things may be helpful, it is often difficult to obtain marketing and other support and financial backing for their literary projects and market to the right group of people (i.e., people who will market and promote the literary work or who have funds and are looking for projects like there project to invest in).

Accordingly, there exists a need for improved systems and methods which allow individuals to effectively advertise and market their literary projects and obtain funding, while at the same time, giving backers a direct percentage of funds received and an ability to diversity their investment over different projects that they can help promote and market.

### SUMMARY OF THE DISCLOSURE

One objective of the present disclosure is to provide computer implemented methods and systems for funding a literary project and paying royalties to backers of the project based on their weighted contribution.

Another objective of the present disclosure is to provide computer implemented methods and systems that give potential backers incentives to market, fund and promote one or more literary project.

In accordance with one aspect of at least one embodiment of the present disclosure, the computer implemented method for financing and publishing a literary project comprises: 1) in an electronic server communicatively coupled to at least one electronic device: receiving at least a description and required budget of a literary project through the electronic device; displaying the description and the required budget on an internet platform or mobile application; receiving money from one or more backer who wants to fund the literary project; calculating weighted contribution for each of the one or more backers who funded the project; 2) publishing the literary project after the required budget is met; 3) receiving revenues generated by the literary project; and 4) paying royalties to the backers based on their weighted contribution.

In another aspect of at least one embodiment of the present disclosure, a computer implemented method for financing and creating a project comprises: 1) in an electronic server communicatively coupled to at least one electronic device; receiving a description and required budget of a project from a creator; displaying the description and the required budget on an internet platform or mobile application; receiving money from one or more backers who want to fund the project; determining the project's likelihood of success in the market based on a predetermined set of factors; contributing money to the required fund based on the project's likelihood of success; calculating weighted contribution for each of the one or more backers who funded the project; 2) producing and marketing the project after the required budget is met or having the project produced or marketed by a third party; 3) providing incentives to backers and other people for them to advertise and/or market the project; 4) receiving revenues generated by the project; and 5) paying royalties to the backers based on their weighted contribution to the project.

The foregoing and other objects, features and advantages of the present disclosure are more readily apparent from the detailed description of the embodiments set forth below, taken in conjunction with the accompanying drawings.

### BRIEF DESCRIPTION OF THE DRAWINGS

FIG. 1 is a process flow diagram showing an embodiment of the present disclosure.

FIG. 2 is a process flow diagram showing another embodiment of the present disclosure.

FIG. 3 is a schematic diagram showing yet another embodiment of the present disclosure.

FIG. 4 is a schematic diagram showing yet another embodiment of the present disclosure.

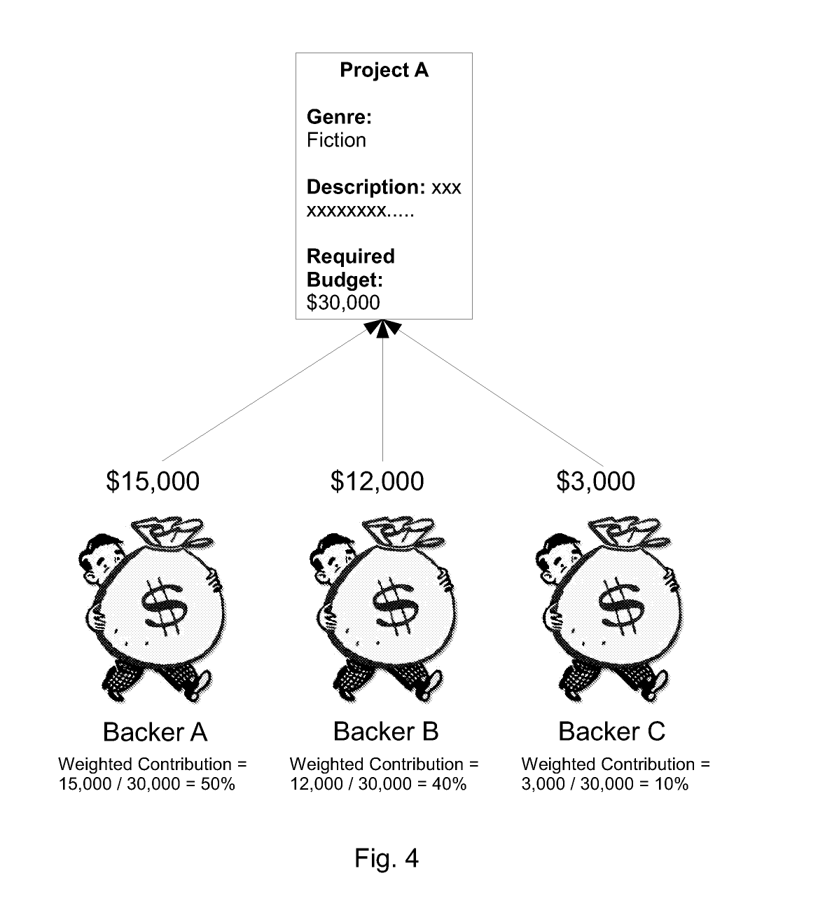

FIG. 5 is a schematic diagram showing yet another embodiment of the present disclosure.

FIG. 6 is a schematic diagram showing yet another embodiment of the present disclosure.

FIG. 7 is a process flow diagram showing yet another embodiment of the present disclosure.

### DETAILED DESCRIPTION OF THE DISCLOSURE

The following description is not to be taken in a limiting sense, but is made merely for the purpose of illustrating the general principles of the disclosure, since the scope of the disclosure is best defined by the following claims. Various inventive features are described below that can each be used independently of one another or in combination with other features.

For purposes of the present disclosure, literary projects include any work which is written, spoken or sung. While the illustrations below mostly use literary project for purpose of demonstrating, it should be noted that the methods and systems disclosed herein can apply to any type of project or business and is not limited to literary project.

Broadly, embodiments of the present disclosure generally provide a computer implemented method for financing and publishing a literary project. The method comprises using an electronic server to receive at least a description and required budget of a literary project through an electronic device; displaying the description and the required budget on an internet platform or mobile application; receiving money from one or more backer who wants to fund the literary project; calculating weighted contribution for each of the one or more backers who funded the project; publishing the literary project after the required budget is met; receiving revenues generated by the literary project; and paying royalties to the backers based on their weighted contribution.

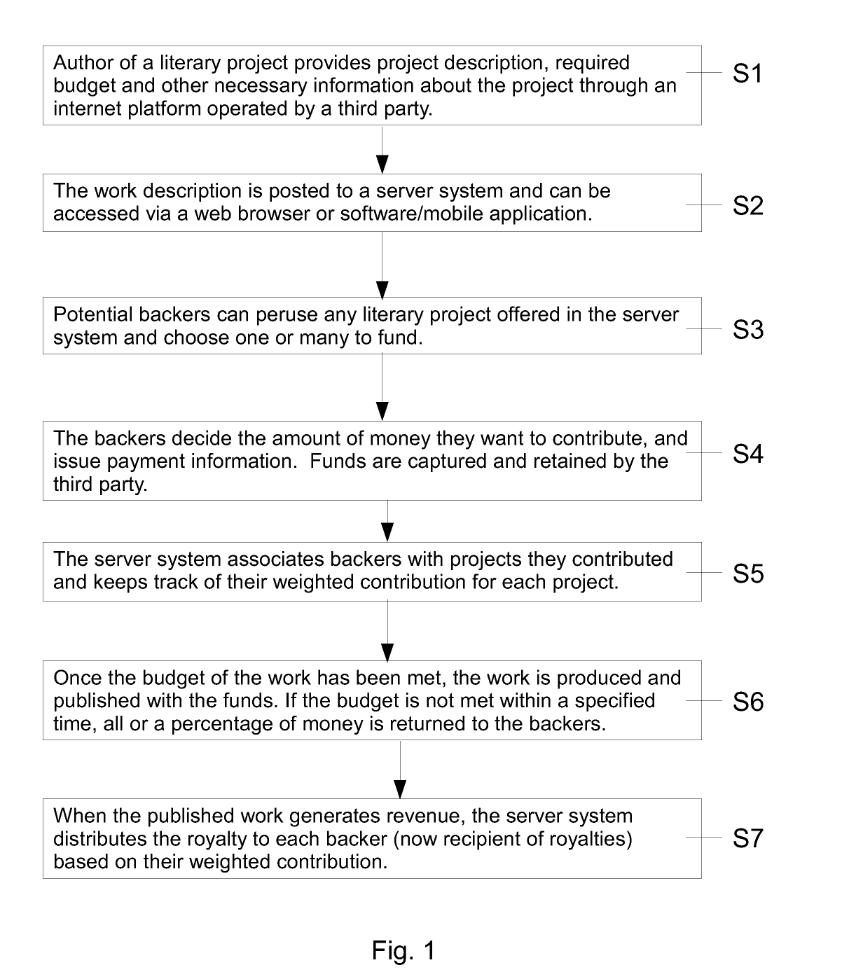

FIG. 1 is a process flow diagram showing an embodiment of the present disclosure which discloses a method for financing and publishing a literary project. In step S1 of FIG. 1, an internet platform or an electronic server system communicatively coupled to one or more electronic device, operated by a system operator or service provider, is provided to allow an author to provide description, required budget and other information about his or her literary project which has not yet been produced or completed. The electronic device can be a computer, tablet computer, PDA or a mobile device. The description may include any information that would be useful to the creator of the literary work, the online system provider, or the backer, including but not limited to the type or genre of the project, the predicted length of the project, author's biography, amount of time required to complete the project and targeted readers, projected or actual sales or price, etc. The required budget is usually the amount of money that is required to publish and market the project. For example, it may include cost to publish the literary project, to market and advertise the literary project and to obtain resources, financial or otherwise, required by the author to complete the project.

In one embodiment of the present disclosure, the required budget can be in multiple levels or phases. For example, a project may consist multiple phases and each phase may require different amount of fund to complete. Instead of raising the fund for all phases at once, the author can raise the fund for one phase at a time and raise the fund for another phase once the previous phase is completed (e.g. sequels of a novel).

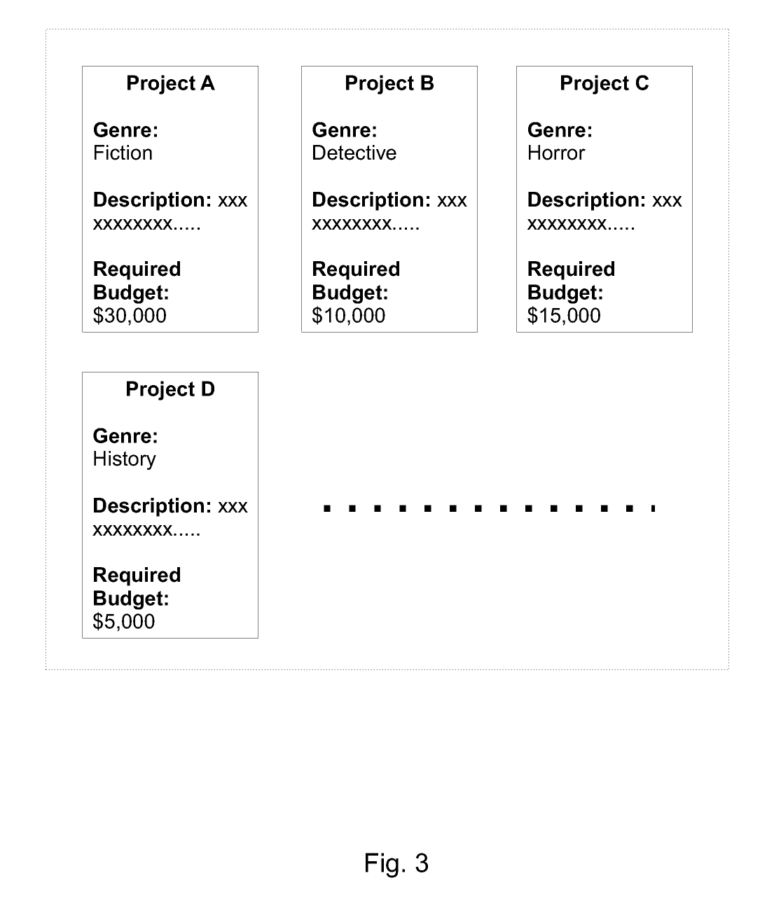

In steps S2 of FIG. 1, after the author provides description, required budget and other information about the project, they will be stored in an electronic server system and posted on a website as shown in FIG. 3. The stored information can be accessed via any electronic means, including but not limited to a web browser, software and/or a mobile application. In one embodiment of the present disclosure, the project information can only be accessed by registered users who have at least provided payment information (i.e., credit card number or bank account) or who have authenticated or verified their identities. In yet another embodiment of the present disclosure, the information can be accessed by anyone who visits the website or uses the software/platform and the person is not required to provide any personal or payment information unless the person decides to fund the project.

In step S3 of FIG. 1, users of the website can peruse the offered projects on the website and decide which one(s) they wish to fund. The system also allows users to sort the projects based on their category or fields, required budget, keyword, duration and/or predict sales etc. so that it is easier for users to find projects they like. Once users (or potential backers or funders) choose the project(s) they want to fund, they then decide the amount of money they want to contribute and provide their payment and personal information as shown in step S4.

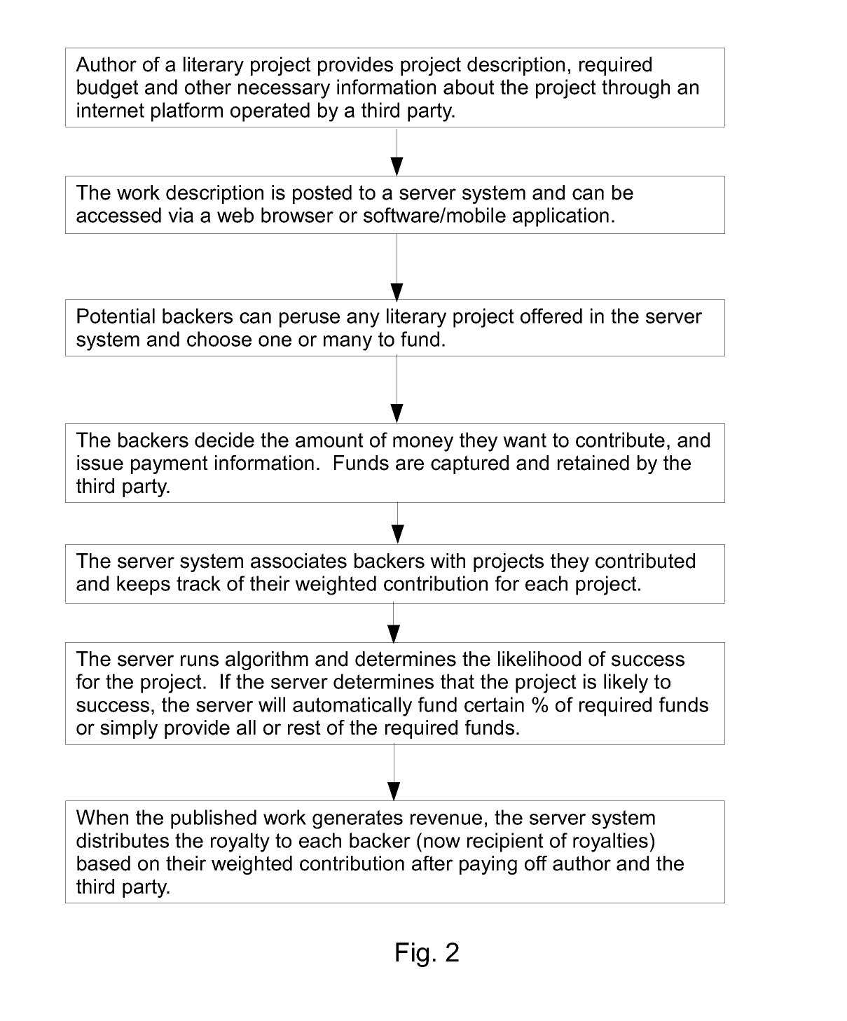

In one embodiment of the present disclosure, as shown by FIG. 2, the server system will run an algorithm to determine the expected sales of or likelihood of success for the project (e.g., estimating how many copies of the project can be sold or predicting the revenues that can be generated from the project). If the server system determines that the project is likely to be successful or having high expected sales, the server may choose to fund certain percentage of the required funds or simply provide all or rest of the required funds based on the level of the predicted success or expected sales. For example and not by way of limitation, if a project requires $30,000 to complete and it has already received a total of $10,000 from backers, the server system may decide to fund 50% of the total (i.e., $15,000) or simply fund rest of the required budget (i.e., $20,000) if the server system determines that the project has high probability of being successful. Alternatively, the server system may contribute or cause at least a party to contribute at least 30% of the require budget when the expected sales of the literary project is higher than 60% of at least some of the previous literary projects. However, the system server may provide little or no funding if it determines that the project has a low probability of being successful.

Factors used in the algorithm to determine the likelihood of success for the project may include, but are not limited to, one or more of the followings: 1) the project's popularity on social networking websites, 2) publicity of the author, 3) number of followers for the project on the internet, 4) successfulness of the creator's prior project(s), 5) uniqueness of the project, 6) expert's review and rating of the project, 6) speed of current funding, 7) number of times the author or the project being mentioned in social media (e.g., facebook® or twitter®) etc., and 8) public interest.

In one embodiment of the present disclosure, the server system will advertise or post the project on social network website(s) and determine the project's expected sales or likelihood of success in the market based at least in part on ratings or reviews received from users of the social networking website.

In yet another embodiment of the present disclosure, the server system will compare its expected sales for a project and the actual sale of the project, and automatically updates the algorithm to increase the accuracy of its future prediction. For example and not by way of limitation, suppose a project receives high ratings from experts but low reviews from users on social networking websites. A server system may determine that the project has high expected sales or high rate of success when it gives more weight to ratings from experts in general or certain experts, in particular. However, if the project does not perform as expected, whether better or worse, the system will modify its algorithm by putting more or less weight on the reviews from users on social network websites rather than ratings from experts in determining whether future projects will be successful. Said a different way, the system adjusts its algorithm/method to more precisely determine which projects are likely to be most successful based on the results of prior projects. Accordingly, the methods and processes of the present invention improve as more and more projects are tested and information regarding their success or lack thereof, is obtained and tabulated.

In yet another embodiment of the present disclosure, all or most of the funds collected from backers will be retained by the system operator (e.g. operator of the website or service provider of the electronic system server) and will not be distributed to the author. The system operator will be the one responsible for publishing and marketing the literary project. An advantage of not passing the fund to the author is that people may feel more secure in funding a project when the fund is being held by a trustworthy third party or when the author is incapable of or less likely to spend the funds on things not related to the project or run off with the funds without ever creating or completing the project. If the author requires fund to complete certain part of the project, the operator will provide the amount of fund necessary or reimburse the author after they verify the funds have appropriately been spent.

In yet another embodiment of the present disclosure, all or a large portion (e.g. more than 80% or 90%) of the money collected will be refunded to the backers if the required budget of the project is not met within a specified range of time or before a set deadline. The fund will also be refunded to the backers if the author cancels the project or for some reason is unable to complete the project.

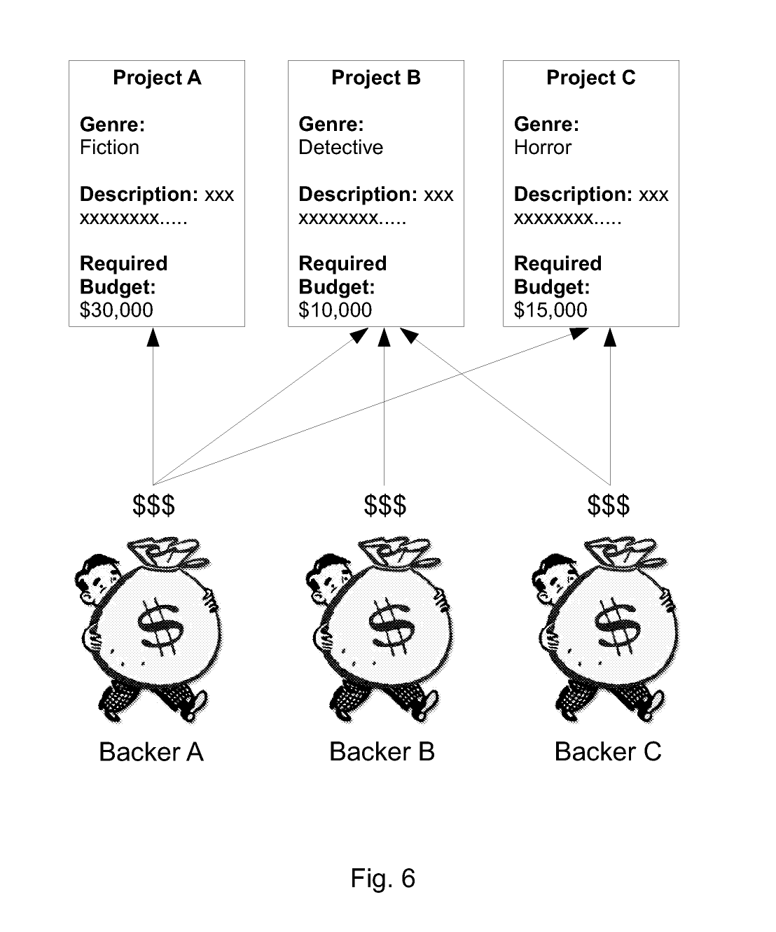

As shown in step S5 of FIG. 1, in yet another embodiment, once a backer contributes to a project, the system server will record and associate the backer with the project. If the backer supports more than one project, each project will be associated separately as shown in FIG. 6. The server system will also calculate and record the weighted contribution for the backer with each project. In one embodiment of the present disclosure and not by way of limitation, the weighted contribution is simply calculated based on the amount of contribution over the required budget. For example, as shown in FIG. 3, Backer A has a weighted contribution of 50% if Backer A contributes $150,000 to a $300,000 project. The weighted contribution can be any means of calculating the amount of effort or money a backer contributes to a project and is not limited to the example above.

In one embodiment, in step S6 of FIG. 1, once the budget goal of the project has been met, the author or of the project or the system operator will be required to execute the project as provided in the original project description. If the system operator is the one that retains the funds, the system operator will be responsible for using the funds to produce and publish the project. The system operator may further be responsible for marketing the project in an open market where it can generate sales.

In yet another embodiment of the present disclosure, backers and others will be rewarded if they assist in advertising and/or marketing the project. The reward may be anything, including but not limited to, a gift, incentive, receiving higher royalties, having the opportunity to interact with the author personally and/or receiving special edition of the project etc. Since the rewards give backers and others the incentive to advertise and promote the project, the project in turn is more likely to receive publicity and become successful.

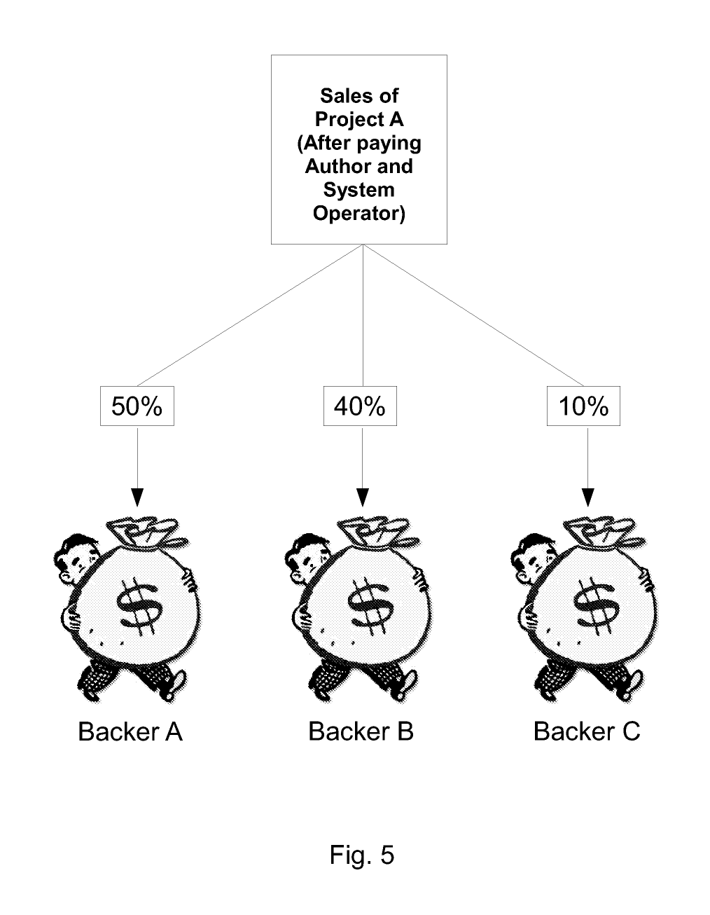

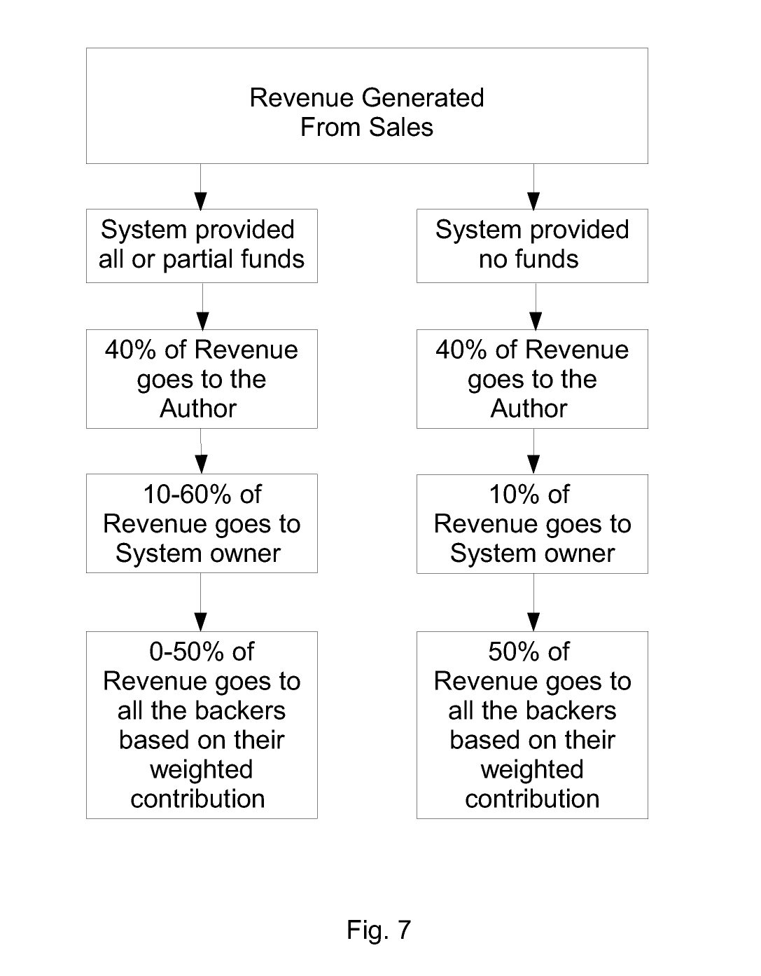

In an aspect of at least one embodiment of the present disclosure, as showing in step S7 of FIG. 1, when the project generates income or when the sales figures come in, the server system or the system operator will pay royalties to backers and the amount of royalties paid to each backer depends on the backer's weighted contribution on the project. The royalty can be calculated in numerous ways. For example and not by way of limitation, the royalty can be a percentage of the generated income after system operator and author received their percentage of shares as shown in FIG. 5. The system operator and the author can be paid with a fixed amount of money or a percentage of the generated income. For example, system operator may receive 10% or more of the generated income, author receives 40% or more of the generated income and 50% or less of the generated income is distributed to backers based on their weighted contribution. However, if the system operator provided all or partial funds, the system operator will receive higher percentage of revenue as shown in FIG. 7 (e.g., 60% of generated income if the system operator funded all the required funds). An advantage of paying royalties to backers based on a percentage of the generated income is that it gives backers incentives to assist in advertising and marketing the project because the amount of backers' royalties is directly correlated to the success of the project. In addition, income may not be limited to simply the sales of the literary work. It may further include any revenue generated by the project such as licensing/related revenue (e.g., sales of promotional materials).

In yet another embodiment of the present disclosure, the author or the system operator may decide the length of time which the backers receive royalties (e.g., 5 years or 10 years) or based on a IRR or annual return for the backer's contribution.

Among other things, the present disclosure provides various benefits and advantages described and discussed above. It should be noted that the method and system disclosed by the present can be used on any type of project or business and is not limited to the literary projects.

It should be understood, of course, that the foregoing relates to exemplary embodiments of the disclosure and that modifications may be made without departing from the spirit and scope of the disclosure as set forth in the following claims.

What is claimed is:

1. A computer implemented method for financing and promoting a literary project, the method comprising:
receiving at least a description and required budget of a literary project at an electronic server which is communicatively coupled to at least one electronic device;
displaying at least the description and the required budget of the literary project on the internet or as part of a mobile application;
receiving money from one or more backers who want to fund the literary project;
calculating weighted contribution for each of the one or more backers who funded the project;
publishing the literary project after the required budget is met;
receiving revenues generated by the literary project; and
paying royalties to the backers based on their weighted contribution.

2. The method of claim 1, wherein the electronic device is a computer, tablet computer, PDA or a mobile device.

3. The method of claim 1, wherein the description includes at least genre of the literary project, estimated time to finish the literary project and predicted length of the literary project.

4. The method of claim 1, wherein the required budget has multiple levels.

5. The method of claim 1, wherein the literary project is any work which is written, spoken or sung, and includes a table or compilation, a computer program, preparatory design material for a computer program, and a database.

6. The method of claim 1 further comprises:
advertising the literary project on social networking website and predicting the likelihood of success of the literary project based at least in part on the literary project's popularity on one or more social networking website.

7. The method of claim 1 further comprises:
refunding all or more than 80% of the money to the backers if the required budget is not met within a specified range of time or before a deadline.

8. The method of claim 1, wherein the weighted contribution of each user is calculated by dividing the money contributed by each user over the required budget.

9. A computer implemented method for financing and publishing a literary project, comprising:
receiving at least a description and required budget of a literary project at an electronic server from an author or creator;
displaying the description and the required budget on the internet or as part of a mobile application;
receiving money from one or more backers who want to fund the literary project or receiving information regarding how much the one or more backers want to fund the literary project;
determining the literary project's expected sales;
funding or causing at least one party to fund at least a portion of the required budget of the literary project based on the literary project's expected sales;
calculating weighted contribution for each of the one or more backers who funded the project;
publishing the literary project after the required budget is met;
having access to revenues generated by the literary project; and
paying the backers or causing the backers to be paid based on their weighted contribution.

10. The method of claim 9, wherein the revenues generated by the literary project include any fees obtained from sales or licensing of the literary project.

11. The method of claim 9, wherein the royalties are paid to the backers for a fixed duration of time.

12. The method of claim 9, wherein all of the revenues received from one or more backers is retained by someone other than the author or creator of the literary project.

13. The method of claim 9, wherein the electronic server updates how it determines expected sales of the based in part on actual sales of the literary project.

14. The method of claim 9, wherein the electronic server contributes or causes at least a party to contribute at least 30% of the require budget when the expected sales of the literary project is higher than 60% of at least some of the previous literary projects.

15. The method of claim 9 further comprises:
providing incentives to backers for them to advertise and assist in marketing of the literary project.

16. A computer implemented method for financing and creating a project, the method comprising:
receiving a description and required budget of a project from a creator at an electronic server which is communicatively coupled to at least one electronic device;
displaying the description and the required budget of the project on the internet or as part of a mobile application;
receiving money from one or more backers who want to fund the project;
determining the project's expected sales;
contributing money to the required budget of the project based on the project's expected sales;
calculating weighted contribution for each of the one or more backers who provided money for the project;
producing and marketing the project after the required budget is met;
providing incentives to backers and other people for them to advertise and assist in marketing of the project.
receiving revenues generated by the project; and
paying money to the backers or causing the backers to be paid based on their weighted contribution.

17. The method of claim 17, wherein factors used to determine the expected sales include one or more of the following: 1) the project's popularity on social networking websites, 2) publicity of the creator, 3) number of followers for the project, 4) successfulness of the creator's prior project(s) and 5) uniqueness of the project.

18. The method of claim 17 further comprises:
advertising the project on social network website and determining the project's expected sales based at least in part on reviews received from users of the social networking website.

19. The method of claim 17, wherein all of the money collected from one or more backers is retained by service provider of the electronic server and the service provider is responsible for using the money collected to create, launch and market the project.

20. The method of claim 17 further comprises:
distributing a fixed percentage of revenues to creator and service provider of the electronic server before paying the royalties to the backers.
